(19) United States
(12) Patent Application Publication
(10) Pub. No.: US 2004/0224815 A1
(43) Pub. Date: Nov. 11, 2004

(54) Gear with integrated angular position mechanism

(76) Inventors: Ken-jen Lang, Bloomfield Hills, MI (US); Teresa Lang, Bloomfield Hills, MI (US); Xiaoyan Liu, Troy, MI (US); Chunhua Zhang, Troy, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/430,573

(22) Filed: May 6, 2003

(51) Int. Cl. B60K 1/02

(52) U.S. Cl. 477/3

(57) ABSTRACT

A system for determining the angular position of a drive shaft in a rotary power plant, such as an internal combustion engine. The system includes a gear having a plurality of circumferentially spaced teeth which is secured to the drive shaft for rotation therewith so that the angular position of the gear corresponds to the angular position of the drive shaft. At least one tooth of the gear is constructed of one of a magnetic material or a non-magnetic material while the other teeth of the gear are constructed of the other of the magnetic material or non-magnetic material. A magnetic sensor is positioned adjacent the gear which generates an output signal when the tooth is in a predefined proximity of the sensor. Advantageously, the gear forms a combination flywheel and timing wheel for an internal combustion engine. A method for constructing the gear is also disclosed.

### BACKGROUND OF THE INVENTION

I. Field of the Invention

The present invention relates generally to gears and, more particularly, to a gear with an integrated angular position mechanism for use in linear or rotary power plants, such as internal combustion engines.

II. Description of Related Art

There are many previously known rotary power plants, such as electric motors, electric generators, compressors and internal combustion engines. These rotary power plants typically have a drive shaft along which power from or to the rotary power plant is transmitted.

In order to ensure stable operation of the rotary power plant, it is conventional to attach a flywheel to the drive shaft. The flywheel is typically made of a heavy material, typically iron, steel or other ferrous material. Due to the weight of the flywheel, the flywheel ensures smooth operation of the rotary power plant.

In order for proper operation of the rotary power plant, especially for internal combustion engines, it is necessary to detect the angular position of the drive shaft during operation. The angular position of the drive shaft is then utilized by the control system for the rotary power plant, e.g. the ignition system and fuel injection system for an internal combustion engine, to ensure the proper timing combustion and the like for the rotary power plant.

Previously, these rotary power plants have utilized a separate timing wheel which is mechanically connected to the drive shaft so that the timing wheel rotates in unison with the drive shaft. However, these previously known timing wheels are not used to transmit power.

Since these previously known timing wheels are separate from the flywheel of the rotary power plant, the timing wheel necessarily entails an additional expense in the overall cost of the rotary power plant, takes space, and increases the weight.

### SUMMARY OF THE PRESENT INVENTION

The present invention provides a unique gear which forms a combination a drive or driven gear, such as a flywheel and timing wheel which overcomes all of the above-mentioned disadvantages of the previously known devices.

In brief, the present invention comprises a gear having a plurality of circumferentially spaced teeth typically formed about the outer perimeter of the gear. The gear is secured to the drive shaft of the rotary power plant such that power is transmitted either to or from the power plant through both the drive shaft as well as the gear.

The gear is constructed of one of either a magnetic material or a non-magnetic material. Conversely, at least one tooth of the gear is replaced with a tooth constructed of a material which is the other of the magnetic material or the non-magnetic material. Any conventional means, such as press fitting, welding, brazing, gluing or the like, may be used to attach the tooth to the gear.

A sensor mounted to the rotary power plant is positioned adjacent the gear. Upon rotation of the gear, the sensor will detect the angular position of the gear whenever the sensor is aligned with the tooth either because the tooth is constructed of a non-magnetic material while the remainder of the teeth are constructed of a magnetic material, or vice versa. Since the gear is coupled to the drive shaft, the output from the sensor provides an output signal representative of the angular position of the gear and thus of the drive shaft. This signal of the angular position of the gear wheel is then used by the control system for the power plant to control, for example, engine ignition timing and the like.

A method for constructing the gear is also disclosed.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a perspective view illustrating a preferred embodiment of the present invention;

FIG. 2 is a fragmentary side view of the preferred embodiment of the present invention;

FIG. 3 is a fragmentary view taken substantially along line 3-3 in FIG. 2;

FIG. 4 is a diagrammatic view illustrating the preferred embodiment of the present invention; and

FIG. 5 is an exemplary signal chart.

### DETAILED DESCRIPTION OF PREFERRED EMBODIMENTS OF THE PRESENT INVENTION

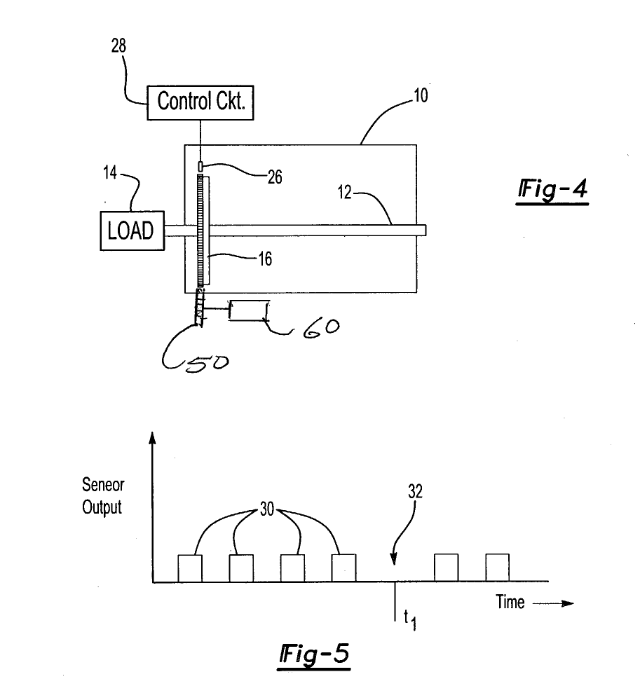

With reference first to FIG. 4, a rotary power plant 10, such as an electric motor, electric generator, internal combustion engine, compressor or the like, is shown diagrammatically. The rotary power plant 10 includes a drive shaft 12 through which power is transmitted to or from a second power source 60, also illustrated diagrammatically. A gear 16 is secured to the shaft 12 so that the gear 16 rotates in unison with the drive shaft 12. Consequently, the angular position of the gear 16 correlates to the angular position of the drive shaft 12. Furthermore, power is able to be transmitted from or to the drive shaft 12 through the gear 16.

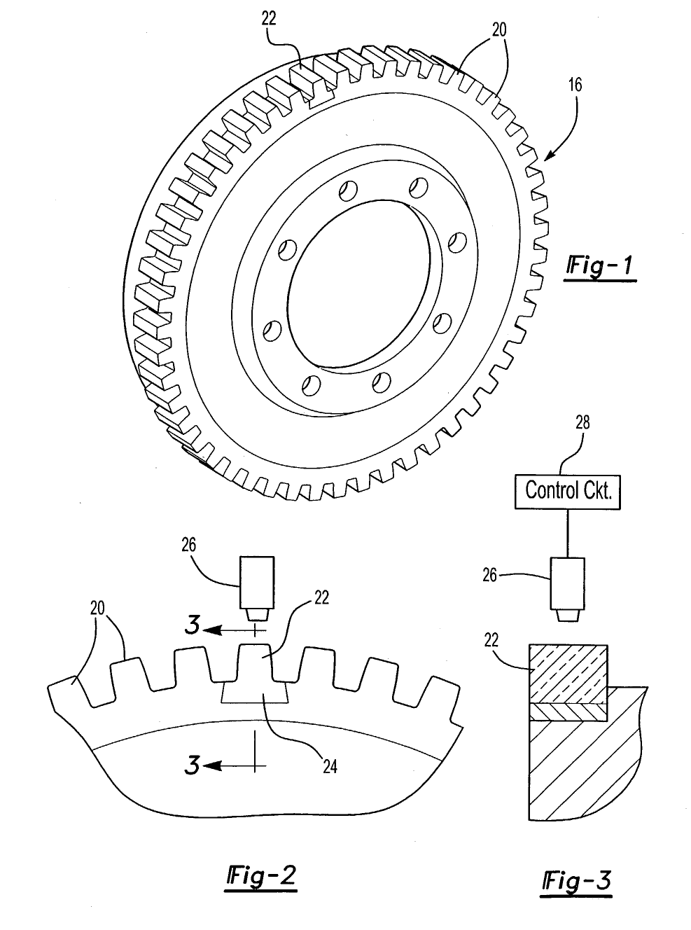

With reference now to FIG. 1, the gear 16 is shown in greater detail and is generally linear or annular in shape having a plurality of circumferentially spaced teeth 20 formed about its outer periphery. In operation, these teeth 20 of the gear 16 mesh with cooperating teeth on other gear 50 such that power is transmitted from or to the shaft 12 through the gear 16.

In the preferred embodiment of the invention, the gear 16 also forms the flywheel and timing wheel for the rotary power plant 10. As such, the gear 16 is constructed of a heavy material and typically a heavy ferrous material that is magnetic. In the well known fashion, the gear 16, operating as a flywheel, ensures smooth operation of the rotary power plant 10 through the inertia of the gear 16 in the case of an internal combustion engine.

With reference now to FIGS. 1-3, at least one tooth 22 of the gear 16 is constructed of a material having opposite magnetic characteristics from the other teeth 20. For example, assuming that the other teeth 20 are constructed of a ferrous magnetic material, the tooth 22 is constructed of a non-magnetic material, such as stainless steel, aluminum alloy, nickel, bronze, ceramics, plastic, composite material, and the like. Conversely, if the teeth 20 of the gear 16 are constructed of a non-magnetic material, then the tooth 22 is constructed of a magnetic ferrous material.

As best shown in FIG. 2, the tooth 22 has the same overall size and shape as the other teeth 20. As such, the tooth 22 is utilized to transmit power to or from the drive shaft 12 just as the other teeth 20 also transmit power to or from the drive shaft 12.

Any conventional means may be utilized to secure the tooth 22 to the gear 16. For example, the tooth 22 could be welded, brazed, glued or otherwise secured to the gear 16. Alternatively, the tooth 22 could be press fit into the gear 16 with an interference fit between the tooth 22 and gear 16. Additionally, as shown in FIG. 2, the tooth 22 may include a dovetail inner end 24 to assist in mechanically locking the tooth 22 to the gear 16.

With reference now to FIGS. 3 and 4, a sensor 26 is mounted to the power plant preferably at a position spaced radially outwardly from the teeth 20 as well as the tooth 22. This sensor 26 detects the presence of the tooth 22 whenever the tooth 22 is within a predefined proximity of the sensor 26 due to the opposite magnetic properties of the tooth 22 relative to the other teeth 20. The sensor 26 then produces an output signal to a control circuit 28 for the rotary power plant 10 whenever the tooth 22 or teeth 20 pass sensor 26 is aligned with the tooth 22.

For example, in the event that the rotary power plant 10 comprises an internal combustion engine having a plurality of combustion chambers, the output signal from the sensor 26 corresponds to the angular position of the gear 16 and thus the angular position of the drive shaft 12. As such, the output signal from the sensor 26 to the control circuit can be used for multiple control functions, including engine ignition timing, speed measurement and control and the like.

With reference now to FIGS. 2 and 5, it will be understood that the sensor 26 may also detect the position of the tooth 22 by the absence of a signal from the sensor 26. Consequently, as used herein the phrase “generates a signal” when used in connection with the sensor 26 means both the generation of a signal as well as the absence of an output signal. For example, assuming that the teeth 20 of the gear 16 are constructed of a magnetic material and that the tooth 22 is constructed of a non-magnetic material, the sensor 26 may generate an output signal to the control circuit 28 whenever it is in close proximity to the teeth 20. Thus, as shown in FIG. 5, the sensor 26 will provide a plurality of spaced output pulses 30 with each pulse corresponding to the alignment of the sensor 26 with one of the teeth 20. However, when the sensor is aligned with the non-magnetic tooth 22 at time t₁, a space or absence of a signal 32 in the pulse train from the sensor output will occur and this space 32 at time t₁ is detected by the control circuit 28 as the position of the tooth 22 and thus of the angular position of the gear 16.

The control circuit 28 processes the output from the sensor 26 in any conventional fashion. A primary advantage of the gear 16 of the present invention is that the gear 16 forms a combination flywheel and timing wheel for the rotary power plant 10. As such, both the necessity and cost of a separate timing wheel utilized with the previously known power plant is entirely eliminated.

Although the present invention has been described for use with a rotary power plant, such as an electric motor, electric generator, internal combustion engine or compressor, no undue limitations should be drawn therefrom. Rather, the gear of the present invention will have many uses in other applications including linear gears.

Having described our invention, however, many modifications thereto will become apparent to those skilled in the art to which it pertains without deviation from the spirit of the invention as defined by the scope of the appended claims.

We claim:

1. For use in conjunction with a rotary power plant having a drive shaft, a system for determining the angular position of the drive shaft comprising:
a gear having a plurality of circumferentially spaced teeth, said gear being secured to the drive shaft for rotation therewith so that the angular position of the gear directly corresponds to the angular position of the drive shaft,
at least one tooth of said gear being constructed of a non-magnetic material,
the other teeth of said gear being constructed of a magnetic material,
a magnetic sensor positioned adjacent said gear which generates a signal when said one tooth is in a predefined proximity of said sensor.

2. The invention as defined in claim 1 wherein said rotary power plant comprises an internal combustion engine.

3. The invention as defined in claim 1 wherein said rotary power plant comprises an electric motor.

4. The invention as defined in claim 1 wherein said rotary power plant comprises an electric generator.

5. The invention as defined in claim 1 wherein said rotary power plant comprises a compressor.

6. The invention as defined in claim 2 wherein said gear comprises a flywheel.

7. The invention as defined in claim 1 wherein said non-magnetic material comprises a non-ferrous material.

8. The invention as defined in claim 1 wherein said magnetic material comprises a ferrous material.

9. (Cancelled)

10. (Cancelled).

11. (Cancelled)

12. (Cancelled)

13. (Cancelled)

14. (Cancelled)
